(19) United States
(12) Patent Application Publication
(10) Pub. No.: US 2013/0161112 A1
(43) Pub. Date: Jun. 27, 2013

(54) MODULAR EXHAUST CARRIER

(71) Applicants: Rebecca M. Grzesiak, Oswego, IL (US); Michael J. Braun, Oswego, IL (US); Reginald R. Vincent, Normal, IL (US)

(72) Inventors: Rebecca M. Grzesiak, Oswego, IL (US); Michael J. Braun, Oswego, IL (US); Reginald R. Vincent, Normal, IL (US)

(73) Assignee: Caterpillar Inc., Peoria, IL (US)

(21) Appl. No.: 13/335,191

(22) Filed: Dec. 22, 2011

(51) Int. Cl. B60K 13/04; B23P 17/00; F16L 9/14; F01N 13/08

(52) U.S. Cl. 180/309; 60/317; 29/890.09; 138/140

(57) ABSTRACT

A modular exhaust carrier for an engine is provided. The modular exhaust carrier includes a first concave shell member and a second concave shell member. The first concave shell member is configured to define one half of an exhaust air passage. Moreover, the first concave shell member either includes a solid wall configuration or a dust ejector opening configuration. The second concave shell member is configured to define a second half of an exhaust air passage. The second concave shell member includes a solid wall configuration or a sensor housing configuration.

### TECHNICAL FIELD

The present disclosure relates to exhaust systems, and more particularly to a modular exhaust carrier for off-road applications.

### BACKGROUND

Exhaust systems are provided in machines to guide waste gases away from an engine. U.S. Pat. No. 7,878,300 relates to a customizable integrated modular exhaust system having a hollow shell muffler body formed from two symmetrical stamp formed shell members that sealably attach to a tailpipe that transverses the hollow shell, and extends through each end of the hollow shell. Exhaust gases are delivered to the muffler body from the engine, by at least one inlet tube communicably attached to the muffler body and connected to the engine via a flange. The muffler body may have various internal configurations, including a disc baffle or catalytic converter configuration.

### SUMMARY OF THE DISCLOSURE

In one aspect, the present disclosure provides a modular exhaust carrier for an engine. The modular exhaust carrier includes a first concave shell member and a second concave shell member. The first concave shell member is configured to define one half of an exhaust air passage. Moreover, the first concave shell member either includes a solid wall configuration or a dust ejector opening configuration. The second concave shell member is configured to define a second half of an exhaust air passage. The second concave shell member includes a solid wall configuration or a sensor housing configuration.

In another aspect, the disclosure provides a method for manufacturing a modular exhaust carrier. The method selects a first concave shell member from a solid wall configuration or a dust ejector opening configuration. The method selects a second concave shell member from a solid wall configuration or a sensor housing configuration. Then, the method disposes first and second flanges, each of the flanges located on longitudinal edges of the selected first and second concave shell members respectively, in a mating arrangement. Subsequently, the method joins the mated flanges of the first and second concave shell members.

Other features and aspects of this disclosure will be apparent from the following description and the accompanying drawings.

### BRIEF DESCRIPTION OF THE DRAWINGS

FIG. 1 is a side view of an exemplary machine having a modular exhaust carrier in accordance with one embodiment of the disclosure;

FIGS. 2 to 5 are diagrammatic views of different variations of the modular exhaust carrier;

FIG. 6 is a side view of another machine having a dual stage pre-cleaner;

FIG. 7 is diagrammatic view of the modular exhaust carrier connected to a dust ejector outlet of the dual stage pre-cleaner of the machine of FIG. 6;

FIG. 8 is a sectional view of the modular exhaust carrier along a plane AA of FIG. 5;

FIG. 9 is a diagrammatic view of the modular exhaust carrier mounted with a sensor; and

FIG. 10 is a process for manufacturing the modular exhaust carrier.

### DETAILED DESCRIPTION

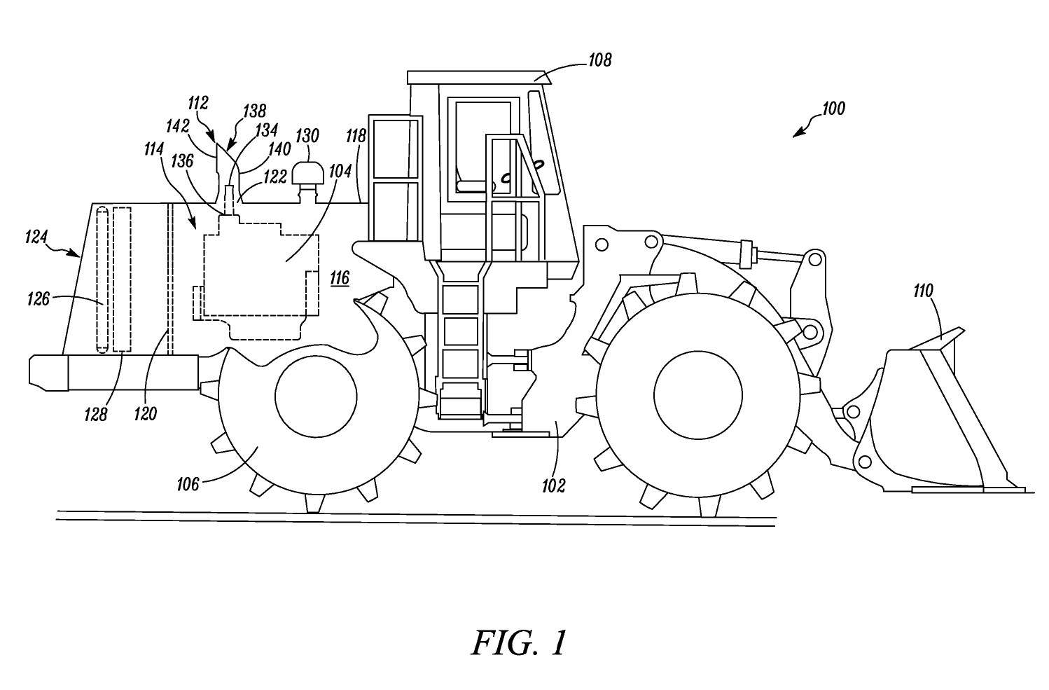

FIG. 1 shows a side view of a machine 100, according to one embodiment of the present disclosure. The machine 100 may include a tracked or a wheeled vehicle, for example, but not limited to, track type loaders, mining shovels, wheel loaders, back hoe loaders, motor graders, track type tractors, wheeled tractors, pavers, excavators, material handlers, forestry machines, or any other machine using an engine. The machine 100 may also be stationary, such as a generator or pump. In an embodiment, as shown in FIG. 1, the machine 100 may embody a landfill compactor which is be used for spreading waste evenly over a landfill, and/or to compact the waste to reduce its volume and help in stabilizing the landfill.

The machine 100 includes a machine frame 102, an engine 104, a plurality of ground engaging members 106, an operator compartment 108, a work implement 110, and an exhaust system 112. The machine frame 102 supports the engine 104 and the operator compartment 108.

The machine 100 further includes an engine compartment 114 carried on the machine frame 102, such that the engine 104 is mounted within the engine compartment 114. The engine compartment 114 may include spaced apart opposed side walls 116, a top wall 118, and an internal rear wall 120. The spaced apart opposed side walls 116, the top wall 118, the internal rear wall 120 define a space within the engine compartment 114 (. The engine 104 is positioned within the space, such that there is a space between the top of the engine 104 and the top wall 118 of the engine compartment 114. Further, an aperture 122 is provided on the top wall 118 of the engine compartment 114.

The engine 104 is operationally coupled to the plurality of ground engaging members 106 such that the engine 104 may drive the plurality of ground engaging members 106, thereby moving the machine 100 within a work area. The engine 104 may also provide power to auxiliary components of the machine 100, such as, machine hydraulics and electromechanical components. The engine 104 may be a petrol engine, diesel engine, or any other kind of engine utilizing combustion of fuel for generation of power.

Further, a radiator fan assembly 124 may be provided. The radiator fan assembly 124 includes a radiator 126 having a coolant flowing therein, and a fan 128. The fan 128 may be a hydraulic fan or driven by power from the engine 104 via, for example, a belt drive, gear drive, or a combination thereof as known in the art. The coolant circulates within the radiator 126 and the fan 128 moves air in a direction across the radiator 126, such that the air flows through the radiator 126 and cools the coolant. The internal rear wall 120 separates the radiator fan assembly 124 from the engine compartment 114.

Furthermore, as shown in FIG. 1, the machine 100 may include a pre-cleaner 130. During operation of the engine 104, the exhaust system 112 facilitates the release of exhaust gases from the engine 104 to the environment. Moreover, the exhaust system 112 may also be associated with the engine compartment 114 for facilitating the release of the cooling air from the engine compartment 114 to the environment. The exhaust system 112 of the machine 100 may further include a modular exhaust carrier 134. The modular exhaust carrier 134 may be coupled with a filter exhaust outlet 136 of the engine 104. The filter exhaust outlet 136 may receive an exhaust airflow from the engine 104. In one embodiment, after combustion, exhaust air may be routed from the engine 104 into a muffler (not shown in figure). In this case, the modular exhaust carrier 134 may be connected to the muffler.

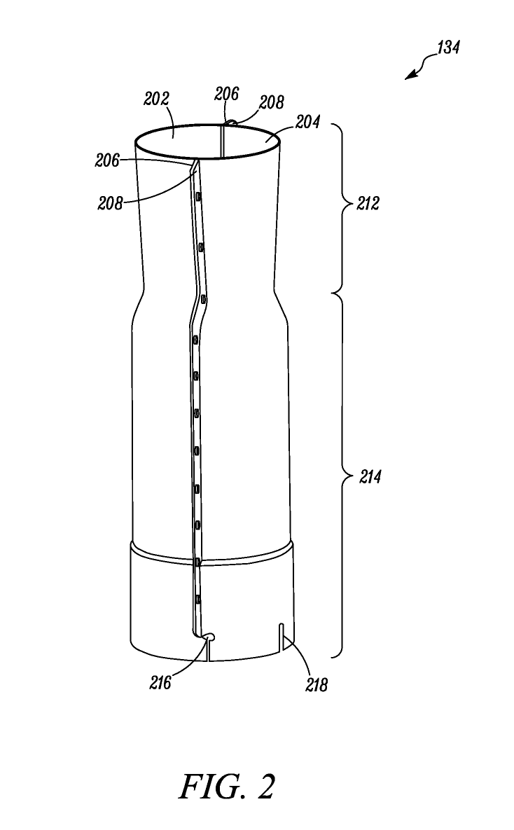

As shown in FIGS. 2 to 5, the modular exhaust carrier 134 may include a first concave shell member 202 and a second concave shell member 204. The first concave shell member 202 may form one half of an exhaust air passage. The first concave shell member 202 may have a first pair of longitudinal edges. Further, the first pair of longitudinal edges may have a first pair of flanges 206 extending along at least a portion thereof. The second concave shell member 204 is symmetrical to the first concave shell member 202. The second concave shell member 206 may form a second half of the exhaust air passage. Similar to the structure of the first concave shell member 202, the second concave shell member 204 may have a second pair of longitudinal edges. Further, the second pair of longitudinal edges may have a second pair of flanges 208 extending along at least a portion thereof. The first and the second concave shell members 202, 204 may be made up of any suitable metal, alloy or any other substance.

The first pair and the second pair of the flanges 206, 208 may be disposed in a mating arrangement. The mated flanges 206, 208 may prevent the escape of exhaust air through the joint between the mated first and second concave shell members 202, 204. In one embodiment, the mated flanges 206 and 208 may be joined by clinching.

The modular exhaust carrier 134 may further include an upper section 212 and a lower section 214. The diameter of the lower section 214 may be greater than a diameter of the upper section 212 of the modular exhaust carrier 134, in order to cause the exhaust air flowing into the modular exhaust carrier 134 from the filter exhaust outlet 136 of the engine 104 to experience a venturi effect. The venturi effect results in an increase in flow velocity of the exhaust airflow and a corresponding decrease in pressure of the exhaust air. Also, the structure of the modular exhaust carrier 134 may assist in maintaining the required velocity of the exhaust airflow and airflow from the engine compartment 114.

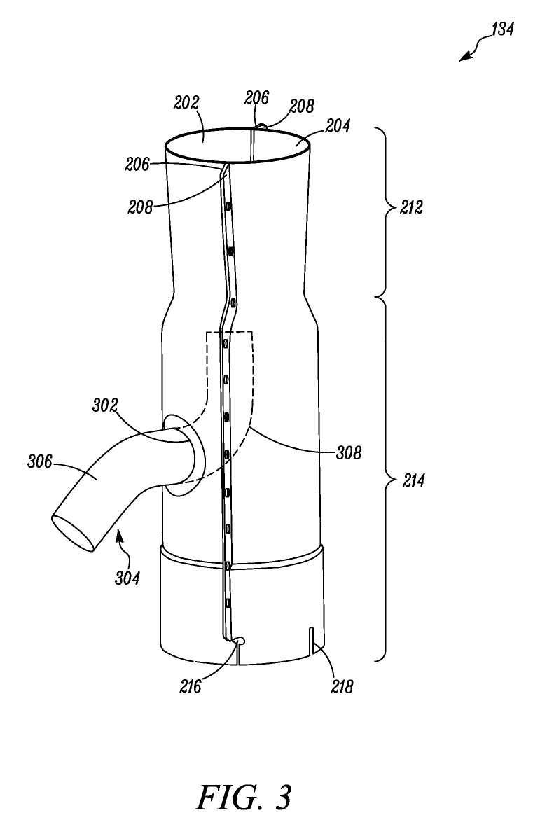

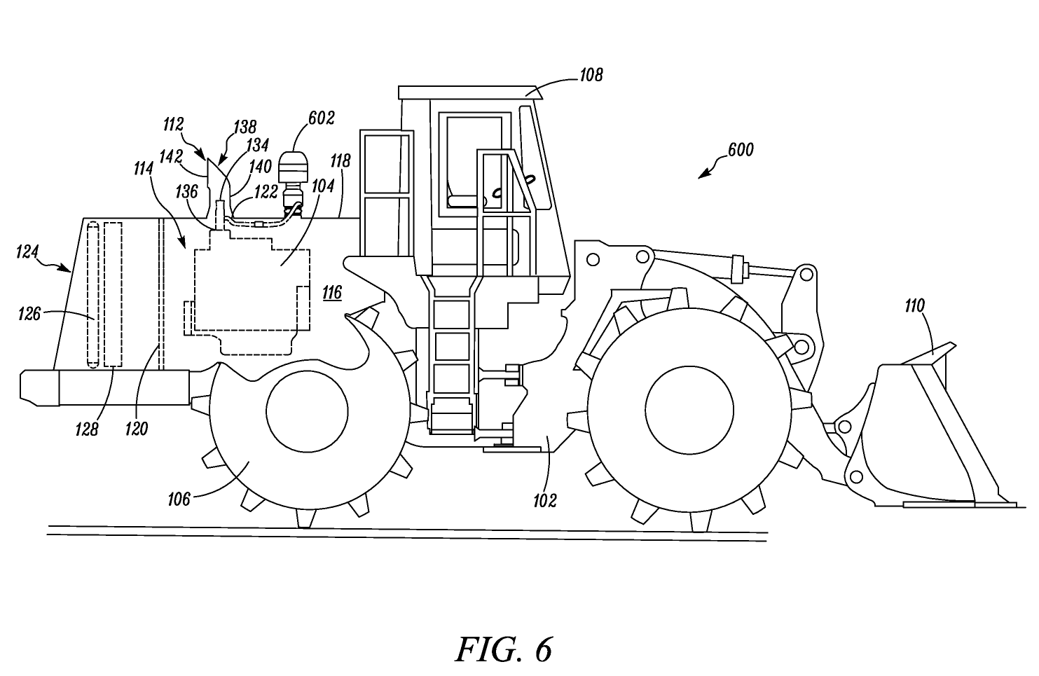

In FIG. 2 a solid wall configuration of the first and the second concave shell members 202, 204 is shown. FIG. 3 illustrates a dust ejector opening configuration of the first concave shell member 202 and the solid wall configuration of the second concave shell member 204. In one embodiment, as shown in FIG. 3, the first concave shell member 202 may include an opening 302 to which a particulate carrier 304 is connected. The particulate carrier 304 is configured to receive a pre-cleaned airflow from a dual stage pre-cleaner 602 present on another machine 600 as shown in FIG. 6. Thus, depending on type of the machine that the modular exhaust carrier 134 is being fitted on, two variations of the modular exhaust carrier 134 are possible, wherein the first concave shell member 202 may either include or not include an opening 302 for the particulate carrier 304 to be attached, as shown in FIG. 3 and FIG. 2 respectively.

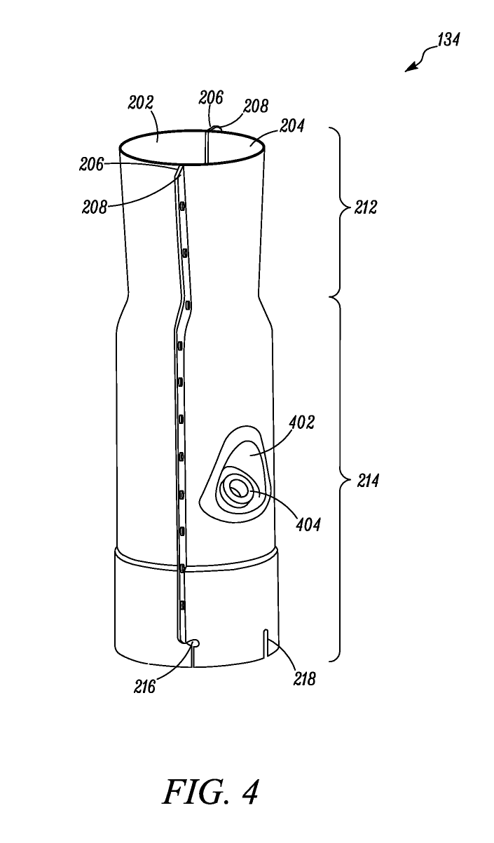

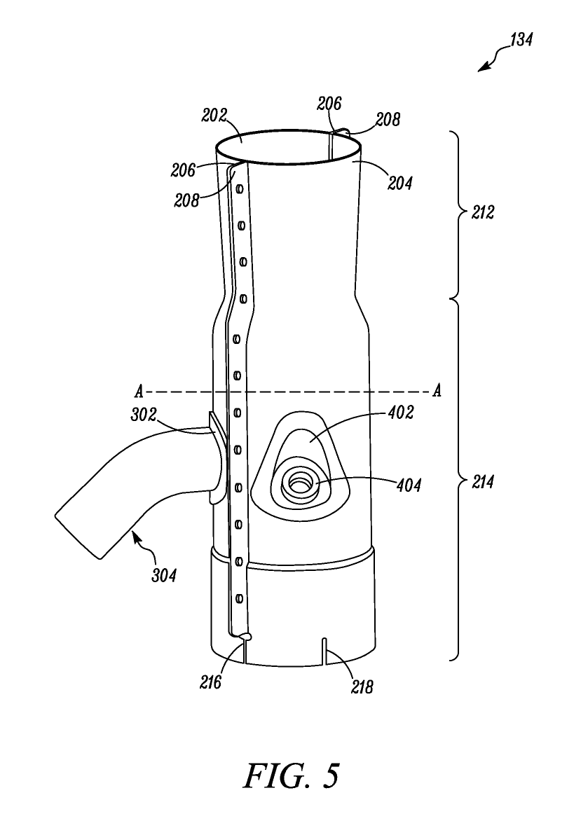

FIG. 4 illustrates the solid wall configuration of the first concave shell member 202 and a sensor housing configuration of the second concave shell member 204. The dust ejector opening configuration of the first concave shell member 202 and the sensor housing configuration of the second concave shell member 204 is shown in FIG. 5. As shown in FIGS. 4 and 5, the second concave shell member 204 may have a dished-in area 402 for mounting a boss 404 in the modular exhaust carrier 134. Depending upon the presence or absence of the mounting for the boss 404 on the second concave shell member 204, another two variations of the modular exhaust carrier 134 may be possible. The boss 404 may be made of stainless steel or any other suitable material.

FIG. 6 illustrates the dual stage pre-cleaner 602 mounted on the machine 600. A person of ordinary skill in the art will appreciate that the machine 600 may include without any limitation, a wheel loader, track-type tractor, hydraulic excavator, skid steer loader, backhoe loader, off-highway truck, on-highway truck or any other suitable machine which may house the dual stage pre-cleaner 602. The dual stage pre-cleaner 602 associated with the machine 600 may be directly or indirectly connected to the modular exhaust carrier 134. The machine 600 described herein may additionally include all parts and components present in the machine 100, as described in connection with FIG. 1.

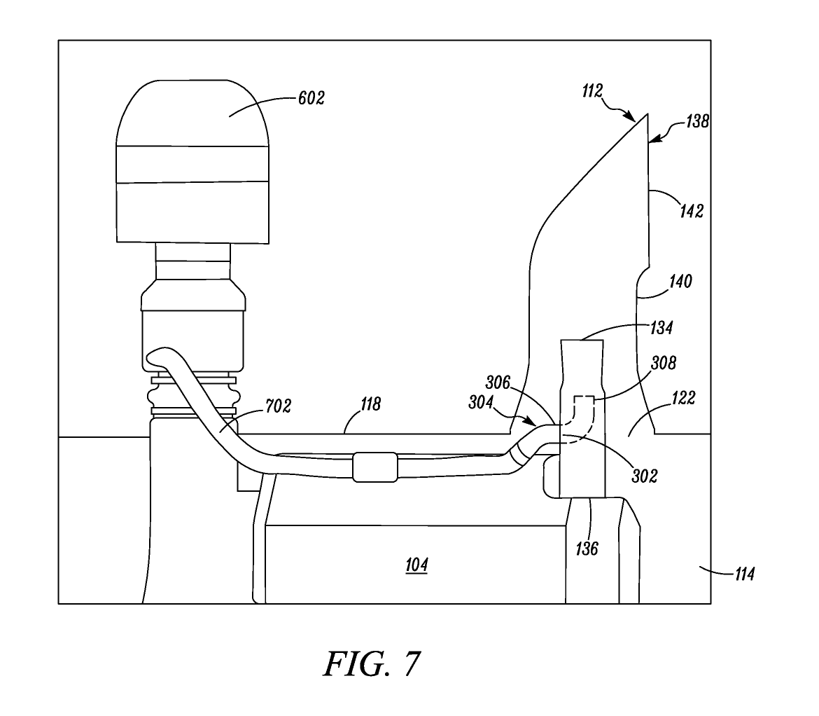

Ambient air may enter the dual stage pre-cleaner 602 of the machine 600. The dual stage pre-cleaner 602 may eject dust and other particulate matter in the ambient air through a dust ejector outlet 702 (as shown in FIG. 7), which is connected to the particulate carrier 304. The pre-cleaned air may assist in bringing about combustion in the cylinders of the engine 104 of the machine 600.

As shown in FIG. 3, the particulate carrier 304 may include a first end 306 and a second end 308. The first end 306 of the particulate carrier 304 is connected to the dust ejector outlet 702 of the dual stage pre-cleaner 602, as shown in FIG. 7. Hence, the first end 306 of the particulate carrier 304 may be external to the modular exhaust carrier 134. Moreover, the second end 306 of the particulate carrier 302 is configured to be housed within the exhaust air passage formed by the modular exhaust carrier 134. The second end 306 of the particulate carrier 302 may be oriented parallel to the exhaust passage formed by the modular exhaust carrier 134. A person of ordinary skill in the art will appreciate that the positioning and orientation of the particulate carrier 302 may be at a pre-determined height so to utilize the venturi effect created by the modular exhaust carrier 134 to urge the pre-cleaned air to enter into the modular exhaust carrier 134.

As shown in FIGS. 1, 6 and 7, an exhaust stack 138 is in communication with the upper section 212 of the modular exhaust carrier 134. The exhaust stack 138 includes an exhaust pipe 140. The exhaust pipe 140 is located downstream of the exhaust airflow and/or pre-cleaned airflow. The exhaust pipe 140 may define an exhaust pipe outlet 142 for expulsion of the exhaust air flow, the pre-cleaned airflow via the modular exhaust carrier 134 and airflow from the engine compartment 114), into the atmosphere.

Additionally, in one embodiment, as shown in FIGS. 2 to 5 and 9, the modular exhaust carrier 134 may also have relief cuts 216 and clamping slots 218 provided at the lower section 214 of the modular exhaust carrier 134 in order to facilitate connecting the modular exhaust carrier 134 to the filter exhaust outlet 136 of the engine 104. The size and dimension of the modular exhaust carrier 134, and material used to form the first and the second shell members 202, 204 may be selected as per the requirement of the machine 100, 600 to which the modular exhaust carrier 134 is mounted. The design and structure of the modular exhaust stack 134 provided herein is on an exemplary basis.

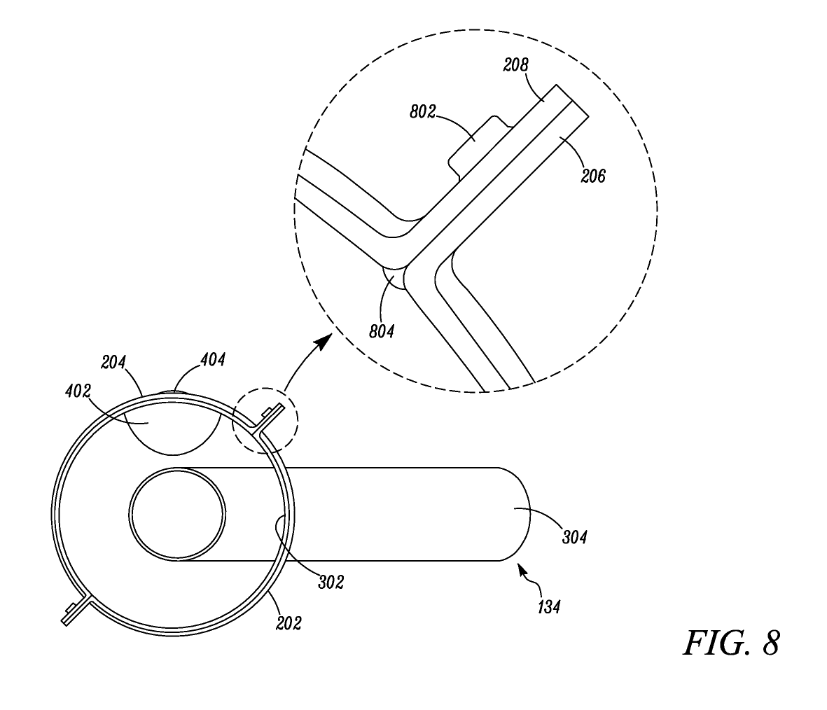

FIG. 8 shows the sectional view of the modular exhaust carrier 134 along a plane AA depicted in FIG. 5. The first and the second concave shell members 202, 204 may be joined by clinching. In one embodiment, the first and second pair of flanges 206, 208 of the first and the second concave shell members 202, 204 may be clinched to form a Tog-L-Loc 802. A person of ordinary skill in the art will appreciate that the Tog-L-Loc 802 is a cold-forming clinch process which utilizes a special punch and die to form a strong interlocking joint, without the use of any external fastener, rivet or weld. The clinching process results in the formation of an extrusion on the die side formed on the first concave shell member 202 or the second concave shell member 204; and a cavity on the punch side formed on the corresponding second concave shell member 204 or the first concave shell member 202.

In another embodiment, a sealant 804 may be provided on an inner surface of the modular exhaust carrier 134 at the joint formed between the first and second pair of flanges 206, 208 of the modular exhaust carrier 134. The sealant 804 may be formed by any suitable material, without any limitation. A person of ordinary skill in the art will appreciate that the joining of the mated flanges 206, 208 described above is merely on an exemplary basis and does not limit the scope of this disclosure. Any similar locking or sealing mechanism may be used to join the first and the second concave shell members 202, 204 of the modular exhaust carrier 134.

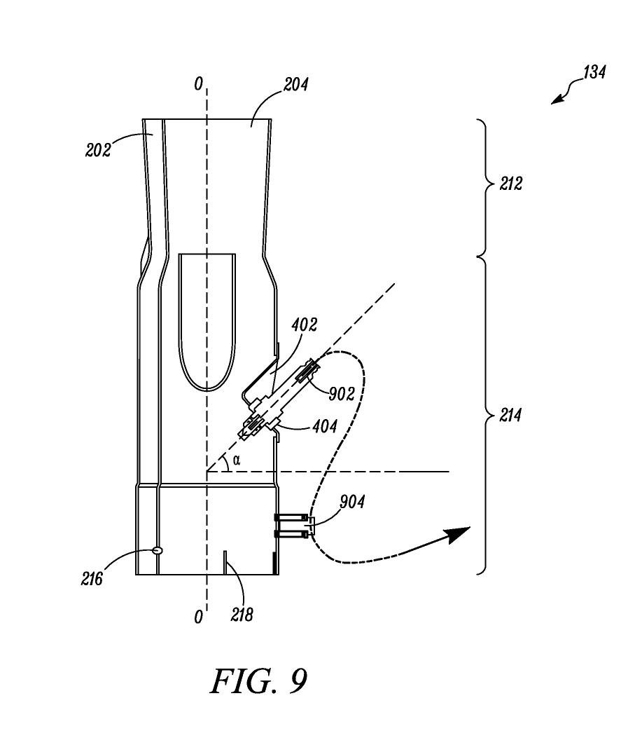

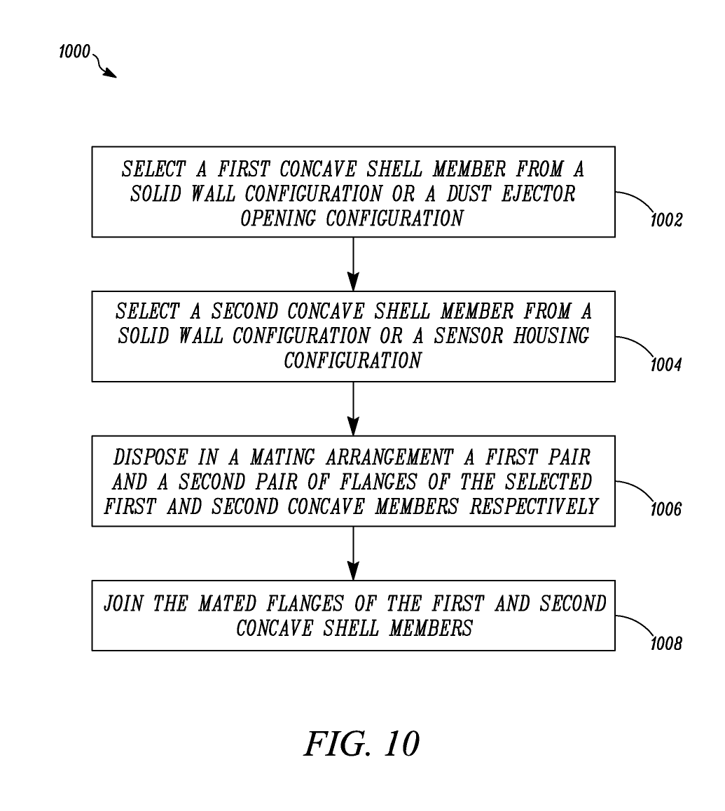

FIG. 9 illustrates the modular exhaust carrier mounted with the boss 404. The dished-in area 402 may be an orthogonal cavity formed on a surface of the second concave shell member 204, as shown in FIG. 9. The position, shape and size of the dished-in area 402 may vary. The boss 404 may be mounted in the dished-in area 402.

In one embodiment, a sensor 902 may be mounted in the boss 404. The sensor 902 may be mounted in the boss at an angle α of 45 degrees with respect to a longitudinal axis OO of the modular exhaust carrier 134. In one embodiment, the sensor 902 may be a nitrogen oxides (NOx) sensor. The sensor 902 may be mounted in order to measure nitrogen oxide level in the exhaust airflow being released into the atmosphere. Compliance with Tier 4 Emission Standards require the exhaust air coming out of the exhaust stack 138 of the machines 100, 600 to have a reduced level of NOx emissions.

In one embodiment, the sensor 902 may be connected to an engine harness via a clipping boss 904 located at the base of the lower section 214 of the modular exhaust carrier 134. The boss 404 provides an interior surface that is disposed at an angle relative to the longitudinal axis of the modular exhaust carrier 134; and thereby provides minimum restriction in the exhaust airflow and/or the pre-cleaned airflow through the exhaust passage of the modular exhaust carrier 134, as is clearly visible in FIG. 8.

### INDUSTRIAL APPLICABILITY

The modular exhaust carrier 134 described above may have four different variations as shown in FIGS. 2 to 5, based on the application. At step 1002, a first concave shell member 202 having either the solid wall configuration or the dust ejector opening configuration is selected. The selection may be based on the type of machine the modular exhaust carrier 134 is being mounted on. In the solid wall configuration, the modular exhaust carrier 134 may be used on a variety of machines 100, such as track type loaders, mining shovels, wheel loaders, back hoe loaders, motor graders, track type tractors, wheeled tractors, pavers, excavators, material handlers, forestry machines, and the like.

In the dust ejector opening configuration, the first concave shell member 202 may include the opening 302 to which the particulate carrier 304 may be connected. This arrangement of the modular exhaust carrier 134 may be used in the machine 600 which includes the dual stage pre-cleaner 602 having the dust ejector outlet 702. Hence, the modular design of the modular exhaust carrier 134 facilitates manufacturing by providing flexibility across different machine configurations meeting all functional requirements with a refined design.

At step 1002, the second concave shell member 204 having either the solid wall configuration or the sensor mounting configuration is selected. The selection of the second concave shell member 204 may be based on requirements laid down for the machines 100, 600 being used in Highly Regulated Countries (HRC) to comply with the Tier 4 Emission Standards.

In the sensor mounting configuration, the second concave shell member 204 may include the dished-in area 402 for mounting the boss 404. The dished-in area 402 formed on the second concave shell member 204 allows ample assembly room for mounting the boss 404 and the sensor 902. The sensor 902 may be mounted in the boss 404, such that the sensor 902 is mounted at the angle a of 45 degrees with respect to the longitudinal axis OO of the modular exhaust carrier 134. In one embodiment, the sensor 902 may be the NOx sensor. Interim Tier 4/Stage III B regulations requires a 50 percent drop in NOx emissions compared to Tier 3/Stage III A. Final Tier 4/Stage IV regulations requires an additional 80% reduction in NOx emissions compared to Interim Tier 4/Stage III B. Hence, the sensor 902 may provide a suitable reading of a level of NOx present in the exhaust airflow being released into the atmosphere. Typical NOx sensor design consists of two internal cavities and three oxygen pumping cells designed to measure both oxygen (air to fuel ratio measurement) and NOx concentrations. Commercially used NOx sensors may be based on zirconia (ZrO2) partly or fully stabilized with ytteria (Y2O3).

In one embodiment, the modular exhaust carrier 134 houses the boss 404. The boss 404 is configured to position the sensor tip at the angle α of 45 degrees with respect to the longitudinal axis OO of the modular exhaust carrier 134, as shown in FIG. 9. This arrangement of the sensor tip within the modular exhaust carrier 134 provides accurate readings of the NOx level in the exhaust airflow. Additionally, the angled interior surface of the dished-in area 402 assists in providing minimal downstream effect to the exhaust airflow. This improved aerodynamic profile provided to the exhaust air flowing through the modular exhaust carrier 134 aids in minimizing back-pressure effects.

Moreover, the modular exhaust carrier 134 provides a cost effective solution which makes use of a stamped design and thereby allows ease in manufacturing. The modularity of the modular exhaust carrier 134 may allow easy shipment and also easy assembly at a remote site.

Subsequently, at step 1006, the first and second pair of flanges 206, 208 of the selected first and second concave shell members 202, 204 are disposed in a mating arrangement. At step 1008, the mated flanges 206, 208 are joined to form the modular exhaust carrier 134. In one embodiment, the joint between the first and the second concave shell members 202, 204 may be formed by clinching of the first and the second pair of flanges 206, 208 of the first and second concave shell members 202, 204 respectively.

Unlike traditional welding methods which make use of heating, the use of the Tog-L-Loc 802 may facilitate in minimizing the deformation of the modular exhaust carrier 134. Moreover, the Tog-L-Loc 802 is a fast, economical and consistent solution that does not require the use of any external fastener. A person of ordinary skill in the art will appreciate that the size, dimensions, shape and positioning of the modular exhaust carrier 134 described above does not limit the scope of this disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A modular exhaust carrier comprising:
a first concave shell member configured to define one half of an exhaust air passage, wherein the first concave shell member either includes a solid wall configuration or a dust ejector opening configuration; and
a second concave shell member configured to define a second half of an exhaust air passage, wherein the second concave shell member includes a solid wall configuration or a sensor housing configuration.

2. The modular exhaust carrier of claim 1, wherein the first and second concave shell members have a first pair and a second pair of longitudinal edges respectively, each of the pair of longitudinal edges including a pair of flanges extending along at least a portion thereof, the first pair and the second pair of flanges of the first and second concave shell members being disposed in a mating arrangement.

3. The modular exhaust carrier of claim 2, wherein the mated flanges of the first and second concave shell members are joined by clinching.

4. The modular exhaust carrier of claim 1, wherein the second concave shell member is symmetrical to the first concave shell member.

5. The modular exhaust carrier of claim 1, wherein in the dust ejector opening configuration, a particulate carrier is connected to an opening of the first concave shell member.

6. The modular exhaust carrier of claim 5, wherein the particulate carrier has a first end and a second end, the second end of the particulate carrier being housed in the exhaust air passage.

7. The modular exhaust carrier of claim 5, wherein the first end of the particulate carrier is in coupled with a dust ejector outlet of a dual stage pre-cleaner.

8. The modular exhaust carrier of claim 1 having a lower section and an upper section, a diameter of the lower section being greater than a diameter of the upper section.

9. The modular exhaust carrier of claim 8, wherein the lower section further includes slots provided for clamping.

10. The modular exhaust carrier of claim 8, wherein the upper section is connected to an exhaust stack.

11. The modular exhaust carrier of claim 1, wherein in the sensor housing configuration, a sensor is mounted in a boss provided in the second concave shell member, the sensor being mounted at angle of 45 degrees with respect to a longitudinal axis of the modular exhaust carrier.

12. The modular exhaust carrier of claim 11, wherein the sensor is a nitrogen oxide sensor.

13. The modular exhaust carrier of claim 2 further including a sealant provided on an inner surface of the modular exhaust carrier at the joint formed between the mated flanges.

14. The modular exhaust carrier of claim 1, wherein the first and the second concave shell members are formed of metallic sheet material.

15. A method comprising:
selecting a first concave shell member from a solid wall configuration or a dust ejector opening configuration;
selecting a second concave shell member from a solid wall configuration or a sensor housing configuration;
disposing in a mating arrangement a first pair and a second pair of flanges, each of the pairs of flanges located on a first pair and a second pair of longitudinal edges of the selected first and second concave shell members respectively; and
joining the mated flanges of the first and second concave shell members.

16. The method of claim 15, wherein joining the mated flanges includes clinching the mated flanges.

17. The method of claim 15 further including applying a sealant on an inner surface of the modular exhaust carrier at the joint formed between the mated flanges.

18. A machine comprising:
an engine compartment;
an engine mounted within the engine compartment, the engine including a filter exhaust outlet;
a modular exhaust carrier in communication with the filter exhaust outlet, and configured to receive an exhaust airflow from the filter exhaust outlet, the modular exhaust carrier including:
a first concave shell member configured to define one half of an exhaust air passage, wherein the first concave shell member either includes a solid wall configuration or a dust ejector opening configuration; and
a second concave shell member configured to define a second half of an exhaust air passage, wherein the second concave shell member includes a solid wall configuration or a sensor housing configuration; and
an exhaust stack in communication with the modular exhaust carrier.

19. The machine of claim 18, wherein in the dust ejector opening configuration, a particulate carrier is connected to an opening of the first concave shell member, wherein the particulate carrier has a first end and a second end, the first end of the particulate carrier being coupled to a dust outlet of a dual stage pre-cleaner and the second end of the particulate carrier being housed in the exhaust air passage.

20. The machine of claim 18, wherein in the sensor housing configuration, a sensor is mounted in a boss provided in the second concave shell member, the sensor being mounted at angle of 45 degrees with respect to a longitudinal axis of the modular exhaust carrier.
